(19) United States
(12) Patent Application Publication
(10) Pub. No.: US 2008/0000811 A1
(43) Pub. Date: Jan. 3, 2008

(54) Mineral Separation Plant Device

(76) Inventors: Bruce Albert Selvey, Queensland (AU); Johannes Arnoldus Kruger, Queensland (AU); Mark Kenneth Palmer, Queensland (AU); Keith Joseph Borg, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/599,750

(22) PCT Filed: Apr. 7, 2005
(86) PCT No.: PCT/AU05/00508

§ 371 Date: Aug. 15, 2007

(30) Foreign Application Priority Data
Apr. 7, 2004 (AU) 2004901878

(51) Int. Cl. B03C 7/12; B03C 1/30; B03C 7/10

(52) U.S. Cl. 209/12.2; 209/127.4

(57) ABSTRACT

The present invention provides an electrostatic separation device to separate components of a mixture of particulates, said device including a means to electrostatically charge said particulates and a first roll and a second roll which are conductive, said first and second roll being arranged one above the other, said device including third and fourth rolls which are also conductive, said first and second rolls each producing a non-conductive output and conductive output, which proceeds respectively to said third roll and said fourth roll, with said first and second rolls producing a mids output, said mids output from said first roll proceeding onto said second roll. The present invention also provides a method of separating particulates from a mixture of particulates, said method including the steps of electrostatically charging said particulates and passing same over a first and second rolls which are conductive, whereby the non-conductive output and conductive output of said first roll bypasses said second roll, said second roll processing only the mids output from said first roll. The present invention also provides a separation plant having such a device or utlising such a method. The present invention further provides an electrostatic and magnetic mineral separation device having a roll onto which a feed of particulate to be separated can be introduced, said roll including a magnetic means associated therewith to allow magnetic forces to act on said particulates and thereby attract said particulates to said roll, said roll also being conductive and said device including a means to electrostatically charge said particulates so that conductive particulate is removed from said roll before non conductive particulate.

### FIELD OF THE INVENTION

The present invention relates to a mineral separation plant device which utilises electrostatic and or magnetic techniques to separate a mixture of particulates, so that desirable particulates can be subsequently extracted and used.

### BACKGROUND OF THE INVENTION

Conventional electrostatic high tension (HT) separator systems utilise a series of three vertically arranged rolls with corresponding electrodes. As particulates fall they cascade over the rolls in a thin curtain. As the particulates pass over the roll they are exposed to an ionising field created by high voltage electrodes and the particulates become charged. Any conductive particulates will, whilst in contact with a roll, impart its charge to the metal roll and will then follow a natural trajectory.

The non-conductive particles cannot discharge as quickly and will be attracted to the surface of the roll due to the disparity between the charged particles and the roll's surface. The non conductive particles will then follow the surface of the roll, as it rotates, to a point where their charge dissipates and they fall off or are removed with a brush.

The applicant does not concede that the prior art discussed in the specification forms part of the common general knowledge in the art at the priority date of this application.

### SUMMARY OF THE INVENTION

The present invention provides a separation device to separate components of a mixture of particulates, said device including means to separate said particulates by electrostatic and or magnetic means in association with first, second, third and fourth rolls, said first and second roll being arranged one above the other and each producing a non-conductive output and a conductive output and or a magnetic and a non-magnetic output, which proceed respectively to said third roll and said fourth roll, with said first and second rolls producing a mids output, said mids output from said first roll proceeding onto said second roll.

Each roll operating with both electrostatic and magnetic separation means is made from a material which is non magnetic and conductive, such as for example stainless steel or is made from a material which is magnetic and conductive and includes means to separate magnetic particles from said roll.

Each roll operating solely with magnetic separation means is made from a non magnetic material or is made from a magnetic material and includes means to separate magnetic particles from said roll.

Each roll operating solely with electrostatic separation means is made from a conductive material.

The first and second rolls can be conductive and have electrostatic separation means associated therewith.

The first and second rolls do not re-treat either of the conductive or non-conductive outputs.

The third and fourth rolls can be conductive and have electrostatic separation means associated therewith

Non-conductive output from the fourth roll, and conductive output from the third roll can join into a single output with the mids output from the second roll.

The fourth roll can be a conductor cleaner and the third roll can be a non-conductor cleaner.

The third roll has a non-conductive, a mids, and a conductive output, or just a conductive and a non-conductive output.

The fourth roll has a conductive, a mids, and a non-conductive output, or just a conductive and a non-conductive output.

The third and fourth rolls can operate with magnetic separation means.

Non-magnetic output from the fourth roll, and magnetic output from the third roll joins into a single output with a mids output from the second roll.

The fourth roll can be a magnetic cleaner and the third roll can be a non-magnetic cleaner.

Magnetic output from the fourth roll, and non-magnetic output from the third roll joins into a single output with a mids output from the second roll.

The fourth roll can be a non-magnetic cleaner and the third roll can be a magnetic cleaner.

The third roll can have a magnetic and a non-magnetic output.

The third roll can also include a mids output.

The fourth roll can have a magnetic and a non-magnetic output.

The fourth roll can also include a mids output.

The first and second rolls can operate with magnetic separation means and do not re-treat either of the magnetic or non-magnetic outputs.

The device can be utilised in a separation plant as a primary stage or roughing stage and or a re-treatment stage.

A separation plant including at least one device as described in paragraphs [0005] to [0026].

The separation plant can have a mids output of the device being fed to a high tension separation device.

A conductive output of the high tension separation device can be fed to an electrostatic plate machine.

The present invention also provides a method of separating particulates from a mixture of particulates, said method including the steps of passing same over first, second third and fourth rolls which are associated with electrostatic and or magnetic separation means, whereby the non-conductive output and conductive output and or the magnetic output and non-magnetic output of said first roll bypasses said second roll, said second roll processing only a mids output from said first roll.

The method can include a step of passing the non-conductive output of said first and second rolls to a third roll, while conductive output of said first and second rolls is passed to a fourth roll.

In the method the non-conductive output from the fourth roll, and the conductive output from the third roll, can join into a single stream with a mids output from the second roll.

In the method, the fourth roll can be a conductor cleaner and said third roll can be a non-conductor cleaner.

The third roll can have three outputs being non-conductive, a mids, and a conductive output. Alternatively the third roll can have only two outputs being a conductive and a non-conductive output.

The fourth roll can have three outputs being a conductive, a mids, and a non-conductive output. Alternatively the fourth roll can have only two outputs being a conductive and a non-conductive output.

The first and second rolls do not re-treat either of the conductive or non-conductive outputs.

The method can include a step of passing the non-magnetic output of said first and second rolls to said third roll, while magnetic output of said first and second rolls is passed to a fourth roll.

Non-magnetic output from the fourth roll, and the magnetic output from the third roll, can join into a single stream with a mids output from the second roll.

The fourth roll can be a magnetic cleaner and said third roll can be a non-magnetic cleaner.

The method can include a step of passing the magnetic output of said first and second rolls to said third roll, while non-magnetic output of said first and second rolls is passed to a fourth roll.

The magnetic output from the fourth roll, and the non-magnetic output from the third roll, can join into a single stream with a mids output from the second roll.

The third roll can be a magnetic cleaner and said fourth roll can be a non-magnetic cleaner.

The third roll can have a non-magnetic output and a magnetic output.

The third roll can also include a mids output.

The fourth roll can have a non-magnetic output and a magnetic output.

The fourth roll can also include a mids output

The first and second rolls do not re-treat either of the magnetic or non-magnetic outputs.

The present invention further provides a separation plant which operates by a method as described above in paragraphs [0030] to [0047].

The present invention also provides a separation plant having a series of said devices as described above.

In the above described inventions electrostatic separation means can includes one or a combination of two or more of the following: an ionising electrode; tribo-electric mechanism; electrostatic plate separator; or other appropriate means so as to positively or negatively charge or polarise said particulates.

The present invention further provides an electrostatic and magnetic mineral separation device having a roll onto which a feed of particulates to be separated can be introduced, said roll including a magnetic means associated therewith to allow magnetic forces to act on said particulates and thereby attract said particulates to said roll, said roll also being conductive and said device including a means to electrostatically charge said particulates so that conductive particulates are removed from said roll before non conductive particulates.

The roll can be manufactured from non magnetic and conductive material. The roll can be made from stainless steel or aluminium.

The magnetic means can be located within said roll.

The magnetic means can be stationary with respect to said roll.

Alternatively, the magnetic means can rotate with said roll.

The roll can be manufactured from a magnetic material which is also conductive, for example the roll can be manufactured from steel. The magnetic means can be stationary with respect to said roll. Alternatively, the magnetic means rotates with said roll.

The roll can be manufactured, at least in part, from a rare earth magnet.

A mechanical means can be provided to assist removal of magnetic particulates from said roll. The mechanical means can be a belt associated with said roll or a non magnetic scraper to remove magnetic particulates from said roll.

The means to electrostatically charge the particulates can include one or a combination of two or more of the following: an ionising electrode; tribo-electric mechanism; electrostatic plate separator; or other appropriate means so as to positively or negatively charge or polarise said particulates.

A device, method or plant as described above can be such that said magnetic separation and said electrostatic separation occur simultaneously on a respective roll. Alternatively they can occur sequentially on a respective roll.

If sequentially the magnetic separation can occur first and electrostatic separation occur second or electrostatic separation occurs first and magnetic separation occurs second.

### BRIEF DESCRIPTION OF THE DRAWINGS

An embodiment or embodiments of the present invention will now be described, by way of example only, with reference to the accompanying drawings, in which:

FIG. 1 is a schematic view of a conventional electrostatic separation device;

FIG. 2 is a schematic view of an improved electrostatic separation device where the third and fourth rolls each have a two stream output;

FIG. 3 is a diagram showing, in cross section of a machine embodying the separation device of FIG. 2, except that the third and fourth rolls each have a three stream output;

FIG. 4 is a flow chart of an improved circuit which utilises the device of FIG. 3;

FIG. 5 illustrates a representative example of the machine of FIG. 2;

FIG. 6 illustrates a representative example of the machine of FIG. 3;

FIG. 7 illustrates a representative example of a machine with a third roll with two outputs, and the fourth roll having three outputs;

FIG. 8 illustrates a schematic of an improved flow process through a machine where the third roll is passing a portion of its output to a fourth roll;

FIG. 9 illustrates a roll arrangement which operates using magnetic separation means;

FIG. 10 illustrates a roll arrangement which utilises both magnetic and electrostatic separation means; and

FIG. 11 illustrates the machine 100 of FIG. 3, with a variety of roll devices in use.

### DETAILED DESCRIPTION OF THE EMBODIMENT OR EMBODIMENTS

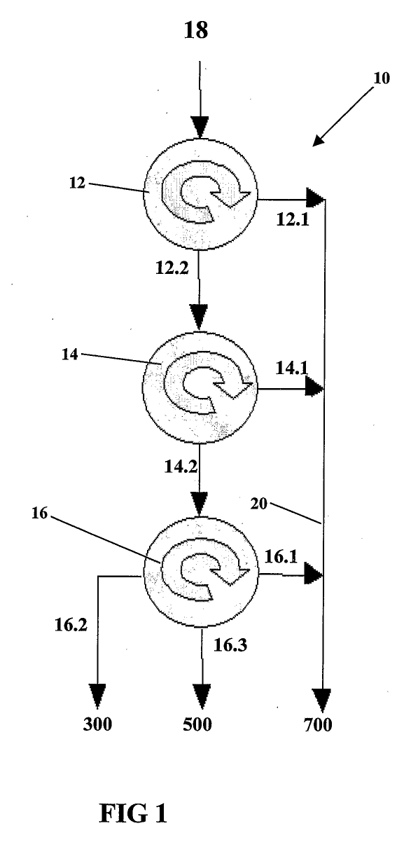

Illustrated in FIG. 1 is a conventional or prior art machine 10, which utilises three rolls 12, 14 and 16. The material to be separated is fed from a feed 18. The material to be separated is electrostatically charged by electrodes (not shown) after it contacts the roll 12, which takes the charge immediately away from those particles which are conductive. The conductive output 12.1 is then gathered, as schematically illustrated on the right hand side 20 of FIG. 1.

Meanwhile, the non conductive particulates, due to their non-conductive nature remain in contact with the roll 12 where their charge slowly dissipates thus allowing them to fall or the non-conductive particulates are brushed or scraped off the roll 12 at path 12.2 and are electrostatically charged again during contact with the roll 14. The process on roll 14 continues in the same manner as for roll 12 with conductors proceeding on path 14.1 and non conductors proceeding on path 14.2. The same occurs in respect of roll 16, except that any non-conductive particulates are separated on path 16.2 to a hopper 300, as are any middlings or mids 16.3 to a hopper 500, with the conductive particulates being moved on path 16.1 to a hopper 700 being the same location as the destination of conductive particulates from rolls 12 and 14. Each roll has its own electrodes for charging.

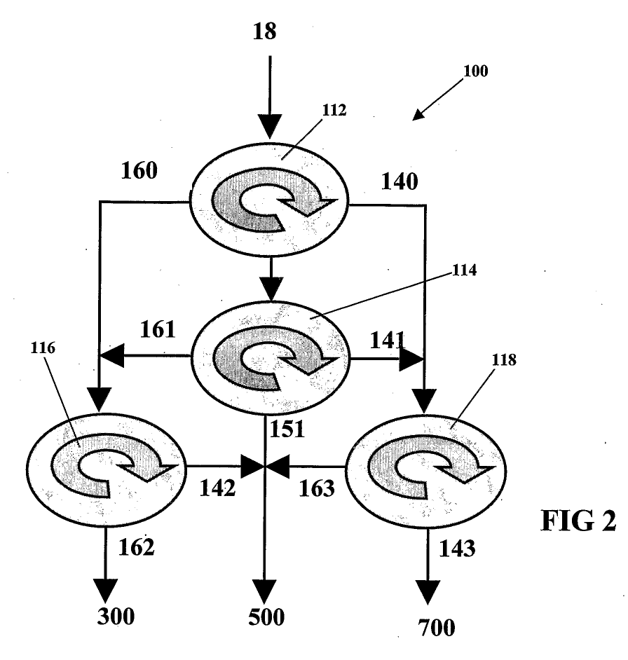

By contrast, the machine 100 embodying the invention is illustrated in FIG. 2. The machine 100 has four rolls 112, 114, 116 and 118.

Particulates to be separated are fed from feed 18 to first and second rolls 112 and 114 which have the conductive particulates output proceed on paths 140 and 141 separated from the particulates stream, and sends this conductive output to the fourth roll 118, where it is cleaned and the conductive output sent via path 143 to its collection area being hopper 700 while any mids on path 163 are sent to the mids collection area being hopper 500.

Likewise, the first and second rolls 112 and 114 have on paths 160 and 161 the non-conductive output of particulates separated from the particulates stream, and sends the non-conductive output to the third roll 116, where it is cleaned and the non-conductive output on path 162 sent to its collection area or hopper 300 while any mids on path 142 sent to the mids collection area or hopper 500.

The mids on path 150 from the first roll 112 are then passed to the second roll 114, whereupon any remaining mids on path 151 are sent to the mids collection area or hopper 500 to join the outputs from the third roll 116 and fourth roll 118.

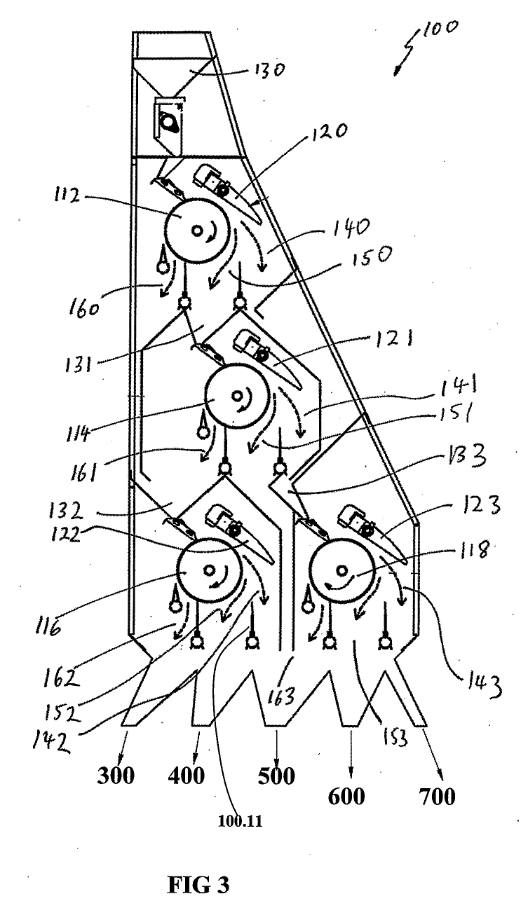

Illustrated in FIG. 3 is a more detailed representation of the machine 100 of FIG. 2, except that the third and fourth rolls 116 and 118 respectively each have three possible outputs.

In this version, the electrodes 120, 121, 122 and 123 and respective separation rolls 112, 114 116 and 118 are of the type described in PCT/AU01/00917 published as WO02/09882, the text and illustrations of which are incorporated herein by reference.

In FIG. 3, the electrode 120 provides an ionising charge to the particulates which are fed out of the feed hopper onto the roll 112 (called a primary roll). The ionising charge on conductive particles is immediately transferred to the roll 112, which is made of a conductive material, such as a chrome plated mild steel, due to the conductive nature of the particulates. Accordingly the conductive particulates are ejected or propelled tangentially in a stream 140 from the roll 112, which is rotating at a rate of between 150 RPM and 250 RPM.

The mids, due to their slower dissipation of charge to the roll 112, will remain attracted to the roll, until the centripetal force from the rotating roll 112 overcomes the force of attraction of the mids particulates to the roll 112. These factors result in the mids leaving the roll 112 tangentially thereto in a mids stream 150, which is at a point on the roll 112 that is angularly spaced or displaced from the point of departure of the conductive output stream 140.

The non-conductive particulates on the roll 112 remain on the roll 112 for the longest time of the three possible outputs. The non-conductive particulates are brushed off the roll 112 to form a non-conductive stream 160.

As can be seen from FIG. 3, the non-conductive stream 160 progresses under gravitational forces to the roll 116 (called a non-conductor cleaner roll), while the conductive stream 140 proceeds directly to the roll 118 (called a conductor cleaner roll). The mids stream 150 from roll 112 proceeds into the feed hopper 131 to be fed to the roll 114 (called a mids re-treat roll). In a similar process to the roll 112, the roll 114 and electrode 121 splits the feed from the hopper 131 into three streams, conductive output 141, mids output 151 and non-conductive output 161.

The non-conductive output 161 proceeds directly to the feed hopper 132 for the roll 116, while the conductive output 141 proceeds directly to the feed hopper 133 for the roll 118. The mids stream 151 proceeds directly to a discharge launder 500 for the middling stream.

Roll 116 and electrode 122 will produce three output streams being a conductive stream 142, a mids stream 152 and a non-conductive stream 162. The non-conductive stream 162 moves directly to a non-conductive collection hopper 300 for a non conductor stream. The conductive stream 142 is only conductive relative to the very non-conductive material in streams 160 and 161. Relative to the original feed from hopper 130, the stream 142 is considered to be middlings and is directed to the middlings hopper 500 of the machine 100.

The middling stream 152, produced from roll 116, is only a middling stream relative to the very non-conductive material in the streams 160 and 161. Relative to the original feed in the hopper 130, the stream 152 is quite non-conductive and is therefore directed to a machine hopper 400 producing a secondary non-conductor stream.

The output from the roll 118 and electrode 123 will produce three output streams being a conductive stream 143, a mids stream 153 and a non-conductive stream 163. The conductive stream 143 moves directly to a conductive collection hopper 700 for a primary conductor stream. The non-conductive stream 163 is only non-conductive relative to the very conductive material in streams 140 and 141. Relative to the original feed from hopper 130, the stream 163 is considered to be middlings and is directed to the middlings hopper 500 of the machine 100.

The middling stream 153 is only a middling relative to the very conductive material in streams 140 and 141. Relative to the original feed from the hopper 130, the stream 153 is quite conductive and is therefore directed to a hopper 600 for a secondary conductive stream.

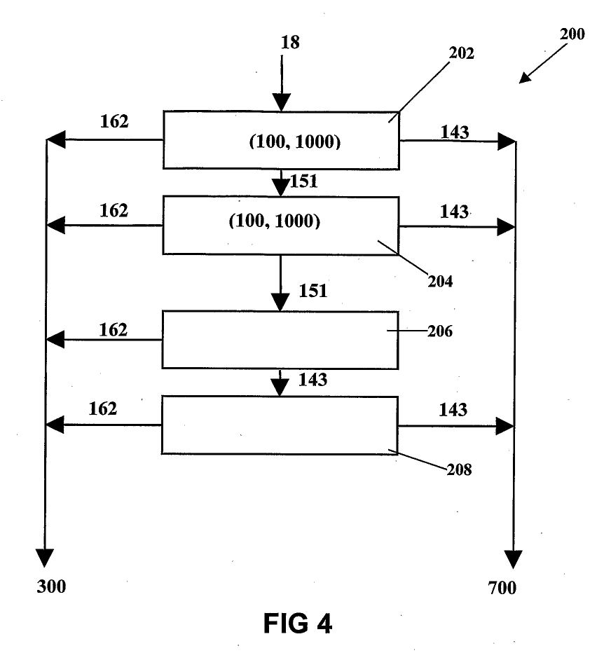

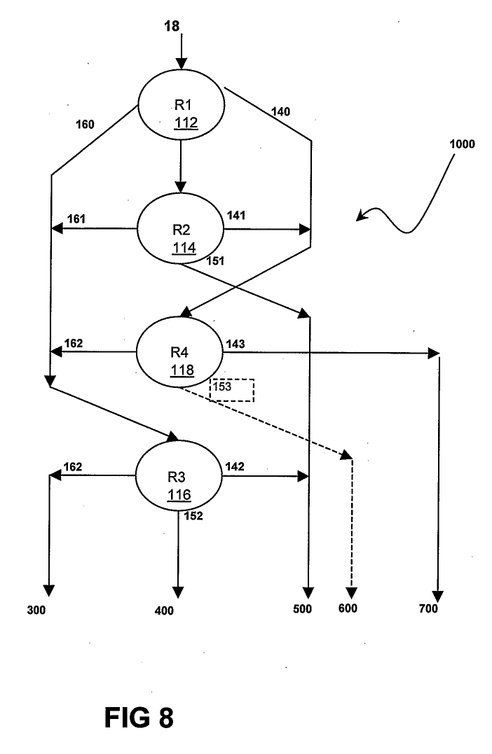

Illustrated in FIG. 4 is schematic of a multistage processing circuit 200, where the first and second stages, being first stage rougher 202 and second stage rougher machine 204, are comprised of separation devices 100 as illustrated in FIGS. 2 and 3 (or 1000 from FIG. 8). In the circuit 200, only the mids resulting from the machine 202 are retreated in the second stage, as the non-conductive and conductive outputs have been cleaned respectively by rolls 116 and 118 in the machine 100 which is part of machine 202. The same happens in respect of the machine 204, with only the mids proceeding to being cleaned by the High Tension Separator machine 206 to extract the remaining conductive particulates and separate them by means of the electrostatic plate machine 208.

The machines 202, 204 and 208 send their final product, being the non conductive streams 162, to hopper 300 while the conductive stream 143 goes to hopper 700.

The machine 202 feeds a mids output 151 to the second stage machine 204. The output 151 may be composed of one or a combination of one or more of the following streams 142, 151, 153, 163 from FIG. 3.

Whether one or a combination of two or more streams is sent to the second stage rougher 204 will be based on the judgement of the operator(s) as well as a function of the quality and or nature of the feed 18 and or the desired output for hoppers 300 and 700.

The operator(s) can control the streams being combined and the destination of each stream by means of moveable flow directors or moveable splitters 100.11, two of which are used in conjunction with each roll 112, 114, 116 and 118, as is illustrated in FIG. 3.

The same will happen for the mids output 151 from second stage rougher 204 into the high tension separator 206.

The high tension separator 206 feeds its conductive output 143 to electrostatic plate machine 208.

At the decision of the operator(s) any mids which are deemed to not be of final product grade can be reintroduced into the circuit 200 at an appropriate location.

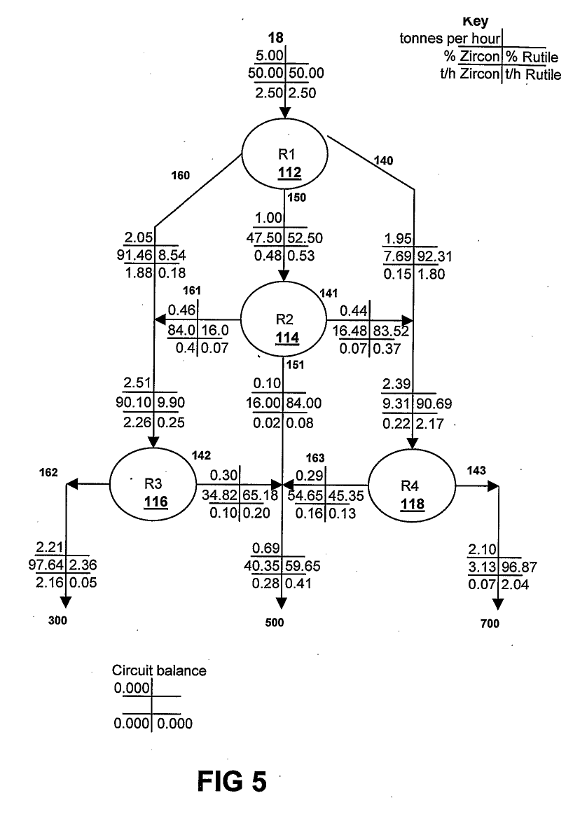

Illustrated in FIG. 5 and table 1 below is an illustrative hypothetical example using a mixture of minerals to be separated, that mixture being 50% Zircon and 50% Rutile. Table 1 is a tabular version of the FIG. 5 information. The machine set up is the same as that for the machine 100 of FIG. 2, where the third roll 116 and fourth roll 118 each have only two output streams, being a conductive outputs 142 and 143 respectively, to the right, and a non-conductive outputs 162 and 163 respectively, to the left. Further the rolls 112 and 114 each have three output streams respectively being: conductive outputs 140, 141; mids or middling outputs 150, 151; and non-conductive 160, 161.

The key as mentioned in the top right hand corner of FIGS. 5, 6 and 7 is such that the nest of figures at each location in the separation process are as follows:

Top left location: number of tonnes per hour input to or output from a roll;

Middle left location: % of Zircon in the stream;

Middle right location: % of Rutile in the stream;

Lower left location: tonnes per hour of Zircon processed; and

Lower right location: tonnes per hour of Rutile processed.

In the example of FIG. 5 the zircon output is the non-conductive particulates, while the Rutile is the conductive particulate. It will be noted that the percentage of Rutile in the conductive output 143 of fourth roll 118 is relatively high, as is the non-conductive output 162 of the third roll 116. Whereas the mids output, being a combination of the streams 151 from second roll 114, and the conductive output 142 from third roll 116 and non-conductive output 163 from fourth roll 118, produces a stream which is obviously not able to be classed as conductive or non-conductive.

TABLE 1

| | Mass | Flow | Zircon (n/c) | | Rutile (cond.) | |
|---|---|---|---|---|---|---|
| Stream | Distribution | rate | grade | Distribution | grade | Distribution |
| Name | % | t/h | % | % | % | % |

Item 112-Roll 1

| | | | | | | |
|---|---|---|---|---|---|---|
| conductive | 39 | 1.95 | 7.7 | 6.0 | 92.3 | 72.0 |
| Mid | 20 | 1.00 | 47.5 | 19.0 | 52.5 | 21.0 |
| Non-conductive | 41 | 2.05 | 91.5 | 75.0 | 8.5 | 7.0 |
| Feed | 100 | 5.00 | 50.0 | 100.0 | 50.0 | 100.0 |

Item 114-Roll 2

| | | | | | | |
|---|---|---|---|---|---|---|
| conductive | 44 | 0.44 | 16.5 | 15.3 | 83.5 | 70.0 |
| Mid | 10 | 0.10 | 16.0 | 3.4 | 84.0 | 16.0 |
| Non-conductive | 46 | 0.46 | 84.0 | 81.4 | 16.0 | 14.0 |
| Feed | 100 | 1.00 | 47.5 | 100.0 | 52.5 | 100.0 |

Item 118-Roll 4

| | | | | | | |
|---|---|---|---|---|---|---|
| conductive | 88 | 2.10 | 3.1 | 29.6 | 96.9 | 94.0 |
| Mid | | | | | | |
| Non-conductive | 12 | 0.29 | 54.7 | 70.4 | 45.3 | 6.0 |
| Feed | 100 | 2.39 | 9.3 | 100.0 | 90.7 | 100.0 |

Item 116-Roll 3

| | | | | | | |
|---|---|---|---|---|---|---|
| conductive | 12 | 0.30 | 34.8 | 4.6 | 65.2 | 79.0 |
| Mid | | | | | | |
| Non-conductive | 88 | 2.21 | 97.6 | 95.4 | 2.4 | 21.0 |
| Feed | 100 | 2.51 | 90.1 | 100.0 | 9.9 | 100.0 |

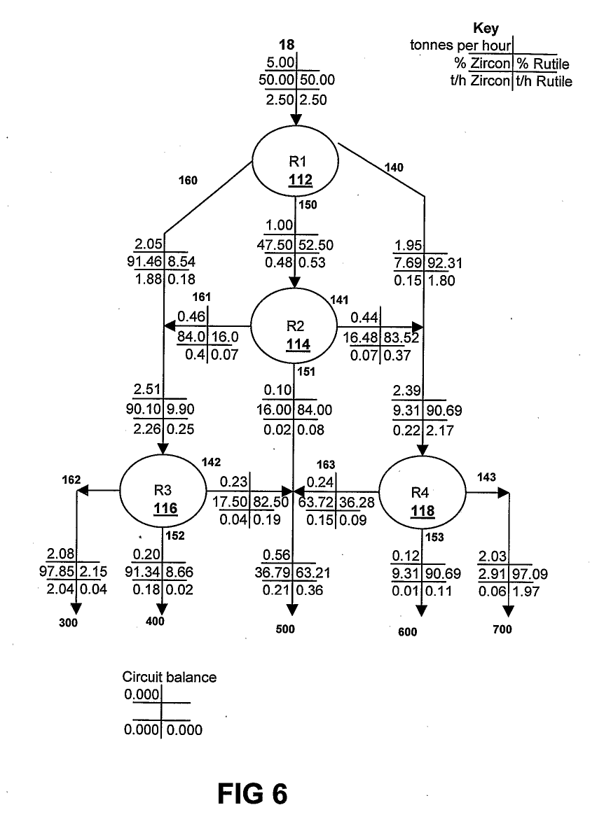

Illustrated in FIG. 6 and table 2 below is another illustrative hypothetical example using the same mixture of minerals to be separated as in FIG. 5. Table 2 is a tabular version of the FIG. 6 information. The machine set up is the same as that for the machine 100 of FIG. 3, where the third roll 116 and fourth roll 118 each have three output streams, being a conductive outputs 142 and 143 respectively, to the right, a non-conductive outputs 162 and 163 respectively, to the left; and mids or middling outputs 152 and 153 respectively. The rolls 112 and 114 also each have three output streams respectively being: conductive outputs 140, 141; mids or middling outputs 150, 151; and non-conductive 160, 161.

In the example of FIG. 6, the zircon output is the non-conductive particulates, while the Rutile is the conductive particulate. It will be noted that the percentage of Rutile in the conductive output 143 of fourth roll 118 is relatively high, as is the percentage of zircon in the non-conductive output 162 of the third roll 116. Whereas the true mids output, being a combination of the streams 151 from second roll 114, and the conductive output 142 from third roll 116 and non-conductive output 163 from fourth roll 118, produces a stream which is obviously not able to be classed as conductive or non-conductive. Further the mids outputs 152 and 153 from the rolls 116 and 118 are sufficiently high in purity to be referred to as second stream non-conductive and conductive outputs respectively. These second streams are sufficiently refined with a high enough percentage of zircon and Rutile respectively, so as to pass into a second stage of separation, separate from the other output streams.

TABLE 2

| | Mass | Flow | Zircon (n/c) | | Rutile (cond.) | |
|---|---|---|---|---|---|---|
| Stream | Distribution | rate | grade | Distribution | grade | Distribution |
| Name | % | t/h | % | % | % | % |

Item 112-Roll 1

| | | | | | | |
|---|---|---|---|---|---|---|
| conductive | 39 | 1.95 | 7.7 | 6.0 | 92.3 | 72.0 |
| Mid | 20 | 1.00 | 47.5 | 19.0 | 52.5 | 21.0 |
| Non-conductive | 41 | 2.05 | 91.5 | 75.0 | 8.5 | 7.0 |
| Feed | 100 | 5.00 | 50.0 | 100.0 | 50.0 | 100.0 |

Item 114-Roll 2

| | | | | | | |
|---|---|---|---|---|---|---|
| conductive | 44 | 0.44 | 16.5 | 15.3 | 83.5 | 70.0 |
| Mid | 10 | 0.10 | 16.0 | 3.4 | 84.0 | 16.0 |
| Non-conductive | 46 | 0.46 | 84.0 | 81.4 | 16.0 | 14.0 |
| Feed | 100 | 1.00 | 47.5 | 100.0 | 52.5 | 100.0 |

Item 118-Roll 4

| | | | | | | |
|---|---|---|---|---|---|---|
| conductive | 85 | 2.03 | 2.9 | 26.6 | 97.1 | 91.0 |
| Mid | 5 | 0.12 | 9.3 | 5.0 | 90.7 | 5.0 |
| Non-conductive | 10 | 0.24 | 63.7 | 68.4 | 36.3 | 4.0 |
| Feed | 100 | 2.39 | 9.3 | 100.0 | 90.7 | 100.0 |

Item 116-Roll 3

| | | | | | | |
|---|---|---|---|---|---|---|
| conductive | 9 | 0.23 | 17.5 | 1.7 | 82.5 | 75.0 |
| Mid | 8 | 0.20 | 91.3 | 8.1 | 8.7 | 7.0 |
| Non-conductive | 83 | 2.08 | 97.9 | 90.1 | 2.1 | 18.0 |
| Feed | 100 | 2.51 | 90.1 | 100.0 | 9.9 | 100.0 |

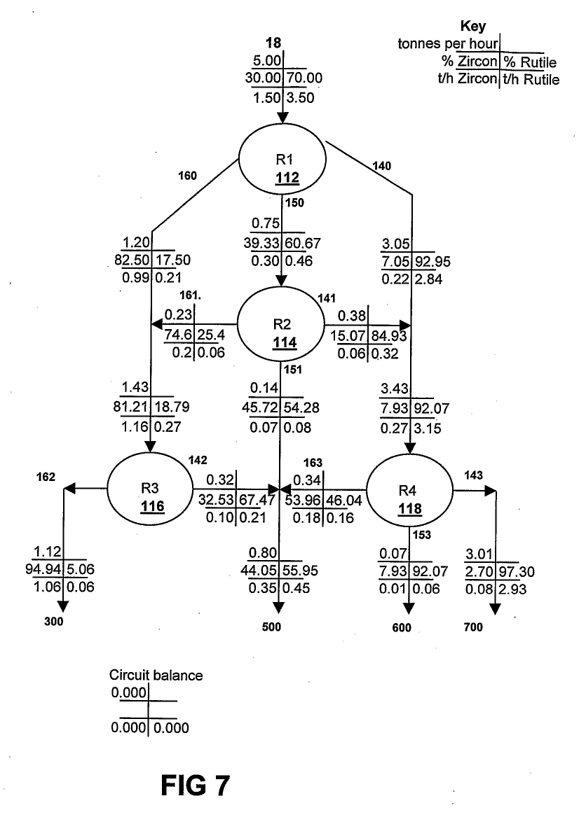

Illustrated in FIG. 7 and table 3 below is further illustrative hypothetical example using a mixture of zircon to rutile in the ratios of 70% to 30%. Table 3 is a tabular version of the FIG. 7 information. The machine set up is different from that of FIGS. 2 and 3, in that the third roll 116 has two output streams being a conductive output 142 and a non-conductive output 162 while the fourth roll 118 has three output streams, being a conductive outputs 143, non-conductive output 163 and a mids output 153. The rolls 112 and 114 also each have three output streams respectively being: conductive outputs 140, 141; mids or middling outputs 150, 151; and non-conductive 160, 161.

In the example of FIG. 7, the zircon output is the non-conductive particulates, while the Rutile is the conductive particulate. It will be noted that the percentage of Rutile in the conductive output 143 of fourth roll 118 is relatively high, as is the zircon content in the non-conductive output 162 of the third roll 116. Whereas the mids output, being a combination of the streams 151 from second roll 114, and the conductive output 142 from third roll 116 and non-conductive output 163 from fourth roll 118, produces a stream which is obviously not able to be classed as conductive or non-conductive. Further the mids output 153 from the roll 118 is sufficiently high in purity to be referred to as second stream conductive outputs. This second stream is sufficiently refined with a high enough percentage of Rutile, so as to pass into a second stage of separation, separate from the other output streams.

TABLE 3

| | Mass | Flow | Zircon (n/c) | | Rutile (cond.) | |
|---|---|---|---|---|---|---|
| Stream | Distribution | rate | grade | Distribution | grade | Distribution |
| Name | % | t/h | % | % | % | % |

Item 112-Roll 1

| | | | | | | |
|---|---|---|---|---|---|---|
| conductive | 61 | 3.05 | 7.0 | 14.3 | 93.0 | 81.0 |
| Mid | 15 | 0.75 | 39.3 | 19.7 | 60.7 | 13.0 |
| Non-conductive | 24 | 1.20 | 82.5 | 66.0 | 17.5 | 6.0 |
| Feed | 100 | 5.00 | 30.0 | 100.0 | 70.0 | 100.0 |

Item 114-Roll 2

| | | | | | | |
|---|---|---|---|---|---|---|
| conductive | 50 | 0.38 | 15.1 | 19.2 | 84.9 | 70.0 |
| Mid | 19 | 0.14 | 45.7 | 22.1 | 54.3 | 17.0 |
| Non-conductive | 31 | 0.23 | 74.6 | 58.8 | 25.4 | 13.0 |
| Feed | 100 | 0.75 | 39.3 | 100.0 | 60.7 | 100.0 |

Item 118-Roll 4

| | | | | | | |
|---|---|---|---|---|---|---|
| conductive | 88 | 3.01 | 2.7 | 29.9 | 97.3 | 93.0 |
| Mid | 2 | 0.07 | 7.9 | 2.0 | 92.1 | 2.0 |
| Non-conductive | 10 | 0.34 | 54.0 | 68.1 | 46.0 | 5.0 |
| Feed | 100 | 3.43 | 7.9 | 100.0 | 92.1 | 100.0 |

Item 116-Roll 3

| | | | | | | |
|---|---|---|---|---|---|---|
| conductive | 22 | 0.32 | 32.5 | 8.8 | 67.5 | 79.0 |
| Mid | | | | | | |
| Non-conductive | 78 | 1.12 | 94.9 | 91.2 | 5.1 | 21.0 |
| Feed | 100 | 1.43 | 81.2 | 100.0 | 18.8 | 100.0 |

In the examples the conductive outputs 143 of FIGS. 5, 6 and 7; second stream conductive output 153 of FIGS. 6 and 7; and the non-conductive outputs 162 of FIGS. 5, 6 and 7; and second stream non-conductive outputs 152 of FIG. 6; and the mids outputs 151 plus 142 plus 163 of FIGS. 5, 6 and 7 are all re-processed through the same machine 100 or a second one of these machines so as to get the refinement of the zircon and the rutile above 99%, whereby the product is then passed through machines 206 and 208 as in FIG. 4, for even greater refinement.

Illustrated in FIG. 8 is an in line arrangement four roll machine 1000, which is similar to the machine 100 described above, and like parts have been like numbered. The machine 1000 differs from the machine 100 in that the fourth roll 118 is positioned so that its non-conductive output can be re-treated by the third roll 116. Otherwise, the machine 1000 is the same as the machine 100 of FIG. 3, where each roll has three output streams.

In the above examples the rolls 112, 114, 116 and 118 all rotate in the clockwise direction, which will mean that the respective ionisation electrodes are positioned on the right hand side of the rolls. This will result in the conductive particulates moving off the roll to the right hand side while the non-conductive particles will remain pinned or attracted to the roll and will separate from the roll at an angularly displaced location. It will be readily understood that if an anti-clockwise rotation were required of the rolls, that the electrodes would be required on the left hand side of the rolls, and the conductive particulates would exit to the left while the non-conductive particles will exit at an angularly displaced location generally to the right of the roll or beneath the roll.

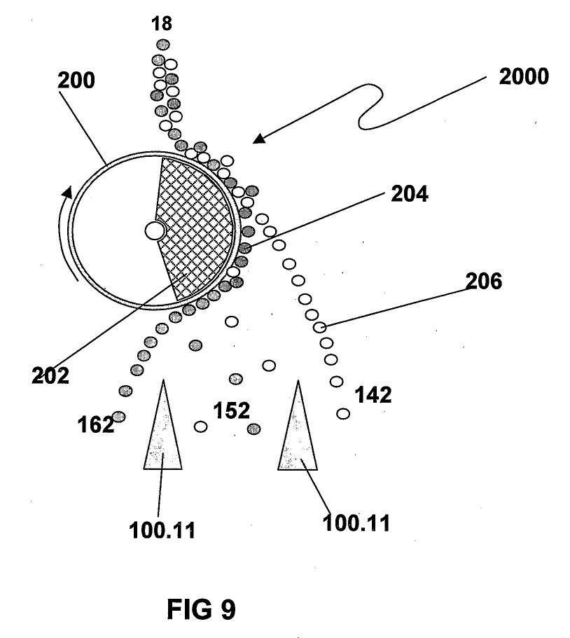

Illustrated in FIG. 9 is a drum separation device 2000 which has a drum 200 formed from a non magnetic material such as stainless steel or fibre reinforced polymer. Inside the drum 200, along a sector of approximately 120° to 180°, is a stationary magnet 202. The magnet 202 will attract magnetic particulates 204 thereby keeping them in contact with the surface of the drum until the magnet 202 terminates. At this point the magnetic 204 particles will fall off in a stream or output 162 while the non magnetic particles 206 will have been thrown off the drum 200 at an earlier location into a stream or output 142.

A middlings or mids stream 152 will generally fall between the streams 162 and 142, and can be made up of magnetic particulates 204 and non magnetic particulates 206. The streams 142, 152 and 162 can be selectively divided or adjusted by means of splitters 100.11 as has been described in respect of the embodiments above

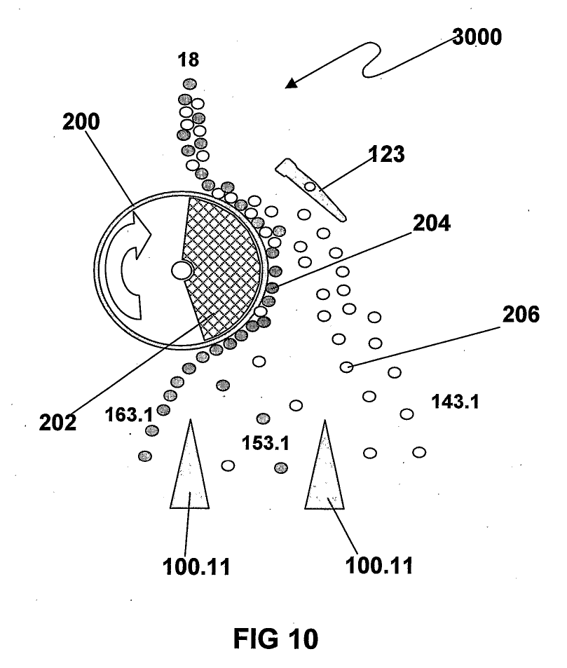

Illustrated in FIG. 10, is a separation device 3000, which utilises both magnetic separation and electrostatic separation. The device 3000 is similar to the device 2000 and like parts have been like numbered. The device 3000 has an additional components namely an ionising electrode 123, which operates in a similar manner to that described above in relation to earlier figures.

The device 3000, as it functions with both magnetic and electrostatic separation mechanisms, needs a drum 200 which is both conductive and non magnetic. In this respect the drum 202 can be manufactured from stainless steel or aluminium. As the drum 200 of device 3000 operates under both electrostatic and magnetic means, the magnetic/non-conductive output has been labeled 163.1, while the non-magnetic/conductive output has been labeled 143.1, with the mids output being labeled 153.1.

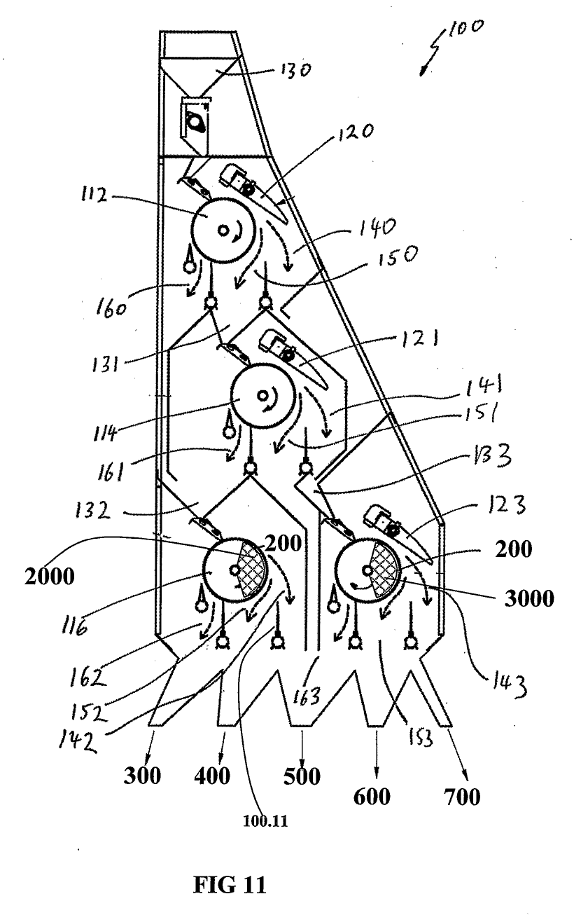

The devices 2000 and 3000 can be used in a machine like the machine 100 of FIG. 3 where that machine has only one type of device 2000, or 3000. Alternatively the machine could be as is illustrated in FIG. 11, that is made up of a combination of device types, to produce a more versatile separator. For example, the machine 100 of FIG. 3, could have all the rolls 112, 114, 116 and 118 being constructed not as electrostatic separators, but as magnetic only devices 2000 or magnetic and electrostatic devices 3000. Alternatively the machine 100, as illustrated in FIG. 11 could have rolls 112, 116 of electrostatic construction while the rolls 114 and 118 are of a construction similar to magnetic only device 2000 and the magnetic and electrostatic device 3000 respectively.

In table 4 is listed a summary of some minerals and their conductive and magnetic properties:

TABLE 4

| | | Non- | | Non- |
|---|---|---|---|---|
| Mineral | Conductive | conductive | Magnetic | magnetic |
| Zircon | | yes | | yes |
| Rutile | yes | | | yes |
| Ilmenite | yes | | yes | |
| Garnet | | yes | yes (moderately | |
| | | | magnetic) | |
| Monazite | | yes | yes (moderately | |
| | | | magnetic) | |
| Native gold | yes | | | yes |
| Native tin | yes | | | yes |

By means of the above table, and by combining electrostatic, magnetic and combined electrostatic and magnetic devices into a single machine a greater flexibility and a potentially larger range of product could be separated by using a single machine.

In the description above relating to FIG. 10, as the location of the stationary magnet 202 is generally coincident with the location of influence of the ionising electrode, the magnetic effect and the electrostatic effect are operating generally simultaneously. If desired, the starting location, namely the edge 210 of magnet 202, can be angularly displaced clockwise to delay the effect of the magnet thereby making sequential the electrostatic effect and then the magnetic separation effect. In this circumstance, to prevent the particulates travelling too far around the drum 200, the angular size of the magnet can be reduced to between 80° and 110°, which is less than the approx. 150° to 180° degrees as illustrated in FIG. 10.

While the above describes the use of drums 200 which are non magnetic, it is envisaged that the drum could be magnetic or that the magnet could be the actual drum, either an electromagnet or a drum made from a rare earth magnet. However, if the drum were magnetic it would be necessary to physically remove the magnetic material, as it will not simply drop off the drum, as in the manner described in FIGS. 9 and 10. To remove the particles a belt system could be utilised or other mechanical means including non magnetic scrapers or such like could be utilised.

Throughout the specification and claims the term “roll” is used to describe a generally cylindrical rotating drum or roller or similar object as is understood by a person skilled in the art. The need for this definition arise because it is understood that the arts of electrostatic separation and magnetic separation different terms are utilised in the respective arts for what would generally be termed the cylindrical rotating drum or roller. For example in the art of electrostatic separation the rotating drum is commonly referred to as a roll or a roller, while in the art of magnetic separation the rotating drum or roller is referred to as a drum.

While the above description of the embodiments illustrates enhanced high tension electrostatic or ionising electrodes of the type mentioned in paragraph [0083], to produce electrostatic charging, positive, negative or polarising charges applied to the particulates can be by any appropriate means such as tribo-electric or electrostatic plate separation means, or other appropriate means.

In the above embodiments of FIGS. 9, 10 and 11, rolls 112, 114, 116 and 118 all rotate in the clockwise direction, which will mean that if ionisation electrodes are used that the respective ionisation electrodes are positioned on the right hand side of the rolls. This will result in the conductive particulates moving off the roll to the right hand side, while the non-conductive particles will remain pinned or attracted to the roll and will separate from the roll at an angularly displaced location. Further the magnetic particles will remain in contact with the roll or belt for a longer period than the non-magnetic particles and thus non-magnetic particles will move off to the right hand side of the roll, while magnetic particles will move off to the left of that stream. It will be readily understood that if an anti-clockwise rotation were required of the rolls, that the electrodes would be required on the left hand side of the rolls, and the conductive particulates would exit to the left with non conductive exiting to the right, and the non-magnetic particles would move off to the left and the magnetic to the right of that stream.

It will be understood that the invention disclosed and defined herein extends to all alternative combinations of two or more of the individual features mentioned or evident from the text. All of these different combinations constitute various alternative aspects of the invention.

The foregoing describes embodiments of the present invention and modifications, obvious to those skilled in the art can be made thereto, without departing from the scope of the present invention.

1. An separation device to separate components of a mixture of particulates, said device including means to separate said particulates by electrostatic and or magnetic means in association with first, second, third and fourth rolls, said first and second roll being arranged one above the other and each producing a non-conductive output and a conductive output and or a magnetic and a non-magnetic output, which proceed respectively to said third roll and said fourth roll, with said first and second rolls producing a mids output, said mids output from said first roll proceeding onto said second roll.

2. (canceled)

3. (canceled)

4. A device as claimed in claim 1, wherein each roll operating solely with electrostatic separation means is made from a conductive material.

5. A device as claimed in claim 1, wherein first and second rolls are conductive and have electrostatic separation means associated therewith.

6. A device as claimed in claim 5, wherein said first and second rolls do not re-treat either of the conductive or non-conductive outputs.

7. A device as claimed in claim 1, wherein said third and fourth rolls are conductive and have electrostatic separation means associated therewith

8. A device as claimed in claim 7, wherein non-conductive output from the fourth roll, and conductive output from the third roll joins into a single output with the mids output from the second roll.

9. A device as claimed in claim 1, wherein said fourth roll is a conductor cleaner and the third roll is a non-conductor cleaner.

10. A device as claimed in claim 1, wherein said third roll has a non-conductive, a mids, and a conductive output, or just a conductive and a non-conductive output.

11. A device as claimed in claim 1, wherein said fourth roll has a conductive, a mids, and a non-conductive output, or just a conductive and a non-conductive output.

12. A device as claimed in claim 1, wherein said third and fourth rolls operate with magnetic separation means.

13. (canceled)

14. (canceled)

15. (canceled)

16. (canceled)

17. (canceled)

18. (canceled)

19. (canceled)

20. (canceled)

21. (canceled)

22. A device as claimed in claim 1, wherein said device is utilised in a separation plant as a primary stage or roughing stage and or a re-treatment stage.

23. A device as claimed in claim 1, wherein said electrostatic separation means includes one or a combination of two or more of the following: an ionising electrode; tribo-electric mechanism; electrostatic plate separator; or other appropriate means so as to positively or negatively charge or polarise said particulates.

24. A separation plant including at least one device as claimed in claim 1.

25. A separation plant as claimed in claims 23, whereby the mids output of said device is fed to a high tension separation device.

26. A plant as claimed in claim 24, wherein a conductive output of the high tension separation device is fed to an electrostatic plate machine.

27. A method of separating particulates from a mixture of particulates, said method including the steps of passing same over first, second third and fourth rolls which are associated with electrostatic and or magnetic separation means, whereby the non-conductive output and conductive output and or the magnetic output and non-magnetic output of said first roll bypasses said second roll, said second roll processing only a mids output from said first roll.

28. A method as claimed in claim 27, wherein there is included a step of passing the non-conductive output of said first and second rolls to a third roll, while conductive output of said first and second rolls is passed to a fourth roll.

29. A method as claimed in claim 27, wherein said non-conductive output from the fourth roll, and the conductive output from the third roll, join into a single stream with a mids output from the second roll.

30. A method as claimed in claim 27, wherein said fourth roll is a conductor cleaner and said third roll is a non-conductor cleaner.

31. A method as claimed in claim 27, wherein said third roll has three outputs being non-conductive, a mids, and a conductive output.

32. A method as claimed in claim 27, wherein said third roll has only two outputs being a conductive and a non-conductive output.

33. A method as claimed in claim 27, wherein said fourth roll has three outputs being a conductive, a mids, and a non-conductive output.

34. A method as claimed in claim 27, wherein said fourth roll has only two outputs being a conductive and a non-conductive output.

35. A method as claimed in claim 27, wherein said first and second rolls do not re-treat either of the conductive or non-conductive outputs.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A method as claimed in claim 27, wherein said electrostatic separation means includes one or a combination of two or more of the following: an ionising or high tension electrode; tribo-electric mechanism; electrostatic plate separator; or other appropriate means so as to positively or negatively charge or polarise said particulates.

48. A separation plant which operates by a method as claimed in claim 27.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)
